(19) United States
(12) Patent Application Publication
(10) Pub. No.: US 2015/0153437 A1
(43) Pub. Date: Jun. 4, 2015

(54) METHOD FOR NAVIGATION AND METHOD FOR INTEGRATING AT LEAST ONE FURTHER TRANSMITTER IN A NAVIGATION SYSTEM

(71) Applicant: Peiker Acustic GmbH & Co. KG, Friedrichsdorf (DE)

(72) Inventors: Tobias BAUMGARTNER, Boblingen (DE); Andreas REIS, Ostfildern (DE); Gero SCHUMACHER, Magstadt (DE); Christoph SCHILLO, Friedrichsdorf (DE)

(21) Appl. No.: 14/616,840

(22) Filed: Feb. 9, 2015

Related U.S. Application Data
(63) Continuation of application No. PCT/EP2013/002373, filed on Aug. 8, 2013.

(30) Foreign Application Priority Data
Aug. 10, 2012 (DE) 10 2012 015 794.0

(51) Int. Cl. G01S 1/68; G01S 5/02

(52) U.S. Cl. CPC G01S 1/68; G01S 5/0252; G01S 5/0289

(57) ABSTRACT

The invention relates to a method for navigation, in particular a method for pedestrian navigation in a building, using a mobile electronic device and a multiplicity of transmitters arranged in the building. In addition, the invention relates to a method for integrating at least one further transmitter in a navigation system, in particular in a pedestrian navigation in a building, in which method the navigation system comprises pre-installed transmitters in addition to the further transmitter(s), at least one electronic device and an application that can run on the electronic device, wherein a floor plan of the building, the locations of the pre-installed transmitters and the identifiers of the pre-installed transmitters are saved in a database of the application.

### CROSS REFERENCE TO RELATED APPLICATIONS

This application is a continuation of International Application No. PCT/EP2013/002373 filed Aug. 8, 2013, which designated the United States, and claims the benefit under 35 USC §119(a)-(d) of German Application No. 10 2012 015 794.0 filed Aug. 10, 2012, the entireties of which are incorporated herein by reference.

### BACKGROUND OF THE INVENTION

1. Field of the Invention

The invention relates to a method for navigation, in particular, a method for pedestrian navigation in a building, and a method for integrating at least one further transmitter in a navigation system.

2. Description of Related Art

US 2010/0121567 A1 discloses a method for indoor and outdoor navigation which uses Bluetooth transmitters as waypoints, in which the Bluetooth transmitters contain the name of the respective waypoint, wherein the locations of the Bluetooth transmitters are known and assigned to a map, and wherein the map is loaded onto a mobile phone.

### SUMMARY OF THE INVENTION

The object of the present invention is to provide a method for navigation that enables improved accuracy of navigation on the basis of Bluetooth transmitters used as waypoints. It is also the object of the present invention to propose a method for integrating additional transmitters in a navigation system that enables the additional transmitters to be integrated with minimum effort.

[1] The method according to the present invention for navigation, in particular, for pedestrian navigation in a building, using a mobile electronic device, in particular, in the form of a mobile communications device, and a multiplicity of transmitters arranged in the building, comprises the steps specified below:

loading into the electronic device an application in the form of a program, wherein a floor plan of the building, a location of each of the plurality of transmitters, which are denoted by coordinates, and the identifiers of each of the plurality of transmitters are saved in a database of the application,

cyclical starting of a scan process to be executed by the electronic device, each scan process comprising the steps of:

searching for signals from transmitters that are present in the vicinity of the electronic device,

detecting the identifier(s) and the signal strength(s) of each of the signals from the transmitters in the vicinity of the electronic device,

terminating communication with the receivable transmitters detected in the vicinity of the electronic device,

ascertaining the current position of the electronic device by comparing the identifier(s) of the detected transmitters with one of the locations of the transmitters and coordinates of the transmitters saved for the transmitters in the database of the application,

specifying more precisely the current position of the electronic device by analyzing the signal strengths for each of the detected transmitters,

ascertaining a movement direction of the electronic device by comparing the current position of the electronic device with at least one previous position of the electronic device,

outputting at least one of the ascertained current position, the ascertained movement direction and further data available on the ascertained position on a display device of the electronic device and logging at least one of the ascertained current position and the ascertained movement direction in the database of the application. Since, by the described method, the current position is ascertained both by ascertaining the transmitters transmitting signals that are receivable (i.e., receivable transmitters) and by analyzing the signal strength of the signals from the receivable transmitters, the current position can be determined more precisely overall and also when transmitters are not in a regular arrangement. The crux of the present invention is hence a dual analysis of the signals received from the transmitters.

[2] According to an advantageous embodiment, the scan process by which the electronic device searches for receivable transmitters is started at intervals of 5 seconds maximum and, in particular, at intervals of 3 seconds maximum. A sufficient number of waypoints for navigation can thereby be ascertained for a person moving at walking speed, i.e. at approximately 3 km/h to 6 km/h.

[3] It is also provided that, in order to determine the individual waypoints even more accurately, the application ascertains an entering and/or a leaving of overlapping transmit ranges of different transmitters by comparing the transmitters detected in two positions reached in immediate succession. Hence a further more precise specification of the coordinates of the current waypoint to be calculated is achieved from the analysis of the transmitter signals detected in two successive scan processes, without capturing further data.

[4] It is additionally provided that the transmitters transmit in accordance with the Bluetooth standard and that the electronic device is operated in accordance with the Bluetooth wireless standard, wherein the scan process in particular is performed in accordance with the Bluetooth 2 standard. It is hence possible to implement the navigation method using economically available standard devices, and in particular, by installing the application to turn even legacy devices into navigation devices, which are used to navigate in accordance with the method according to the present invention. According to an embodiment variant, it is also provided to operate the transmitters and the electronic device according to another wireless standard that is suitable for navigation, in particular with regard to power consumption and speed in establishing communication. In particular, the transmitters are designed such that, irrespective of the wireless standard used, they automatically go into a power-saving standby mode when they are not needed for navigation.

[5] It is also advantageously provided to operate all the transmitters at the same transmit power, which is designed to be of such a level that the transmit signal from each transmitter is received by the electronic device at a defined minimum transmit power at a distance of 2 to 5 meters. This makes it possible to apply more precisely the process of ascertaining the position on the basis of measured transmit powers, which is one element of the entire position-ascertainment process, because the one center position between two transmitters can be determined more easily from two matching transmit powers from the two transmitters.

[6] According to an advantageous embodiment, communication of the electronic device with the transmitters is performed such that in a connecting state of the electronic device, which is intended to set up a connection with another device such as a transmitter, for example, communication is made only as part of the sub-state of an inquiry process, avoiding an initiation or implementation of the sub-state of a paging phase. This reduces the time in which the electronic device is in the connecting state needed for detecting the transmitters, so that a new inquiry process can be started after a shorter time, and the number of waypoints that can be ascertained per unit of time increases. In this context it is also provided, in particular, to run the method such that a renewed inquiry process takes place immediately in time after the previous inquiry process and while the waypoint is still being calculated from the data of the previous inquiry process.

[7] The length of the inquiry process is preferably shortened such that the process is terminated after a time interval that is shorter than an “interlaced scan” according to the Bluetooth standard, or after at least three transmitters have been discovered. This reduction means that it is possible to track the position of the electronic device at short time intervals, including when the electronic device is moving faster. In addition, the shortened scan-time achieves without further technical measures that primarily the transmitters closer to the electronic device are discovered, and the position can be determined more accurately from the signal strengths from these transmitters than from the signal strengths from other transmitters further away, because the signal strengths from the closer transmitters are normally subject to less interference.

In particular, the inquiry process is terminated after 3 seconds at the latest and preferably after 2 seconds, in order then to be able to start a new inquiry process immediately, so that when the electronic device is moving, as many waypoints as possible can be ascertained per unit of time. In particular, one waypoint and one movement direction can be ascertained at least every 3 seconds and preferably at least every 2 seconds. To achieve this, the program is designed to execute in the electronic device such that incompletely detected transmitters are ignored, and such errors do not affect the execution of the software.

The general method for calculating the waypoints takes into account the fact that sometimes during a shortened inquiry process not all the transmitters in the immediate vicinity of the electronic device can be detected. This increases the robustness and reliability of the method for calculating the waypoints. The missing information, i.e. the information about undetected transmitters, can also be supplied later directly in one of the next shortened inquiry process and one of the subsequent shortened inquiry processes. Although this may improve the waypoint calculation is not essential to the method.

Shortening the inquiry process also increases the probability of detecting, while the mobile device is moving, further transmitters that were not located in range of the mobile device at the beginning of the inquiry process. The reason for this is that transmitters are mostly detected at the beginning of the inquiry process, and using repeated short inquiry processes counteracts this behavior.

[8] With regard to execution of the inquiry process, the electronic device is operated in the scan process as a master, wherein the vicinity of the master is scanned for data transmitted by Bluetooth transmitters working as slaves, and, avoiding the paging phase, the scan process dispenses with responding to data received by the electronic device from the Bluetooth transmitters so that the electronic device exits the connecting state again after as short a time as possible. In other words, the mobile electronic device is operated with respect to the transmitters present for navigation as much as possible so as to be repeatedly in the first phase, the inquiry phase, of the connecting state, avoiding an unconnected state and avoiding a connected state.

In order to keep the time required for determining a position as short as possible and to be able to determine as many waypoints as possible, an advantageous embodiment of the invention is designed to shorten the inquiry interval intended for the inquiry process and to lengthen the inquiry window in order to increase the response rate of the transmitters. In addition, the advantageous embodiment is also designed to place the transmitters in interlaced mode in order thereby to cover both possible frequency bands of the Bluetooth inquiry scan. This avoids a reduction in the number of discovered transmitters on the mobile electronic device despite the shortened scan interval. More frequent and more rapid detection of the Bluetooth transmitters is achieved by an interval adjustment performed both in the master, i.e. in the Bluetooth module of the electronic device, and in the slave, i.e. Bluetooth transmitter. The characteristic feature of the communication between master and slave, i.e. between the electronic device and the transmitter, is an incomplete connection-setup process, which is terminated before entering the paging phase. That is to say, the object of the method is not a complete connection-setup process for the purpose of establishing a data transfer by means of conventional profiles, but to ascertain the identifier of the detected transmitters at the same time as also ascertaining the respective signal strength of the transmitters. The described procedure avoids violating the requirements of the Bluetooth specification despite the incomplete connection-setup process. In addition, there is also no need to modify the existing Bluetooth stacks.

[9] The method according to the present invention for integrating at least one further transmitter in a navigation system, in particular in a navigation system for pedestrian navigation in a building, in which the navigation system comprises pre-installed transmitters in addition to the further transmitter(s), and at least one electronic device with an application that can run on the electronic device, wherein a floor plan of the building, the locations of the pre-installed transmitters and the identifiers of the pre-installed transmitters are saved in a database of the application, the method comprising the steps of:

placing the further transmitter(s) in the building;

then moving the electronic device through the building while the application is running;

the application navigating on the basis of the pre-installed transmitters, in accordance with a method of [1] to [7];

wherein the application, on receiving the identifier of one of the newly placed further transmitter(s), calculates the location of the newly placed further transmitter in relation to the pre-installed transmitters, saves the newly placed further transmitter as a newly installed transmitter in the database and uses the newly installed transmitter for further navigation. It is thereby possible while the navigation system is running to make this system both more accurate by the transmitters being arranged more densely, and to increase the spatial extent of the navigation system by arranging further transmitters always adjacent to transmitters already saved in the database.

[10] In one embodiment, the method for integrating at least one further transmitter in a navigation system of [9] advantageously provides that when

the navigation system includes a central computer, the method further comprising the steps of:

signaling the location of the newly installed further transmitter from each electronic device to the central computer;

logging the transmitted locations at the central computer;

ascertaining at the central computer from the received coordinates of the transmitted locations of a newly installed further transmitter, after analyzing the signals from at least two electronic devices, a definitive location of the newly installed further transmitter, and passing this definitive location to the electronic devices so that the electronic devices save the newly installed further transmitter as an installed transmitter and use the newly installed further transmitter for navigation. The newly installed further transmitters are thereby available to all the electronic devices being operated in the navigation system.

Finally, it is provided to use the application in the electronic device to derive from the identifier of each transmitter, without querying a database, the coordinates of the location, which are held by the individual transmitter in a reference system used for navigation. It is thereby possible to keep the memory size required by the application small. For instance, the coordinates can be calculated from the identifier using a suitable formula, or the coordinates are used to generate the identifier of each transmitter.

### BRIEF DESCRIPTION OF THE DRAWINGS

Further details of the present invention are described with reference to schematic diagrams of exemplary embodiments in the drawing.

FIG. 1 is a plan view of a floor plan of a building containing transmitters arranged therein;

FIG. 2 is the diagram shown in FIG. 1 with the coordinates hidden;

FIG. 3 is a magnified view of a segment of the diagram in FIG. 1; and

FIG. 4 is a schematic view of an electronic device in communication with two transmitters.

### DETAILED DESCRIPTION OF THE INVENTION

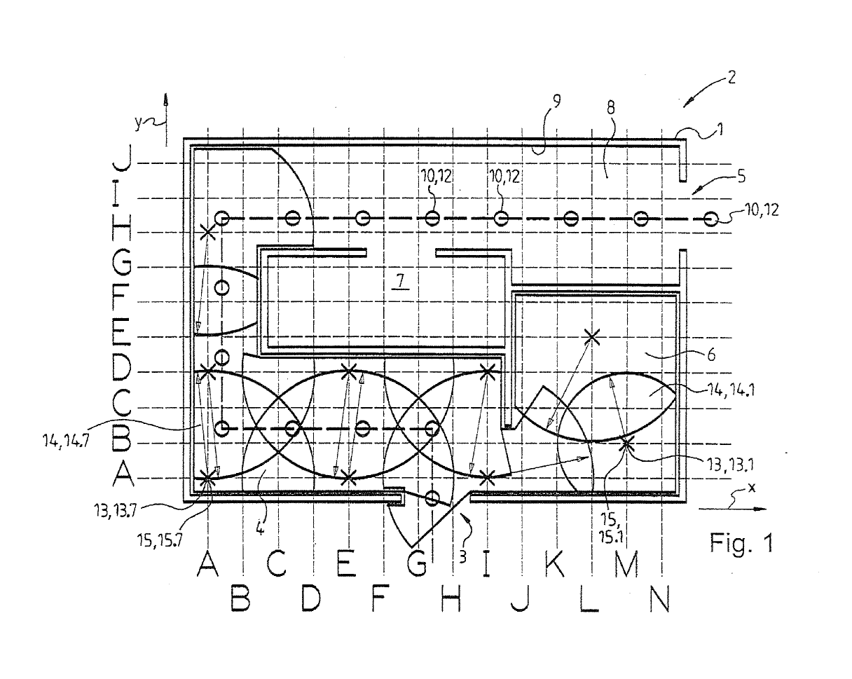

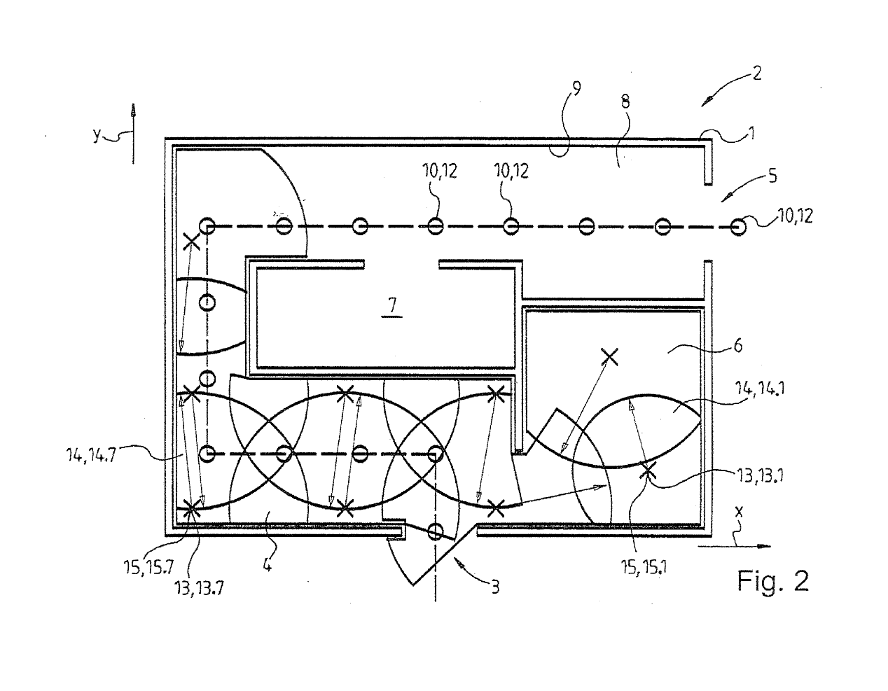

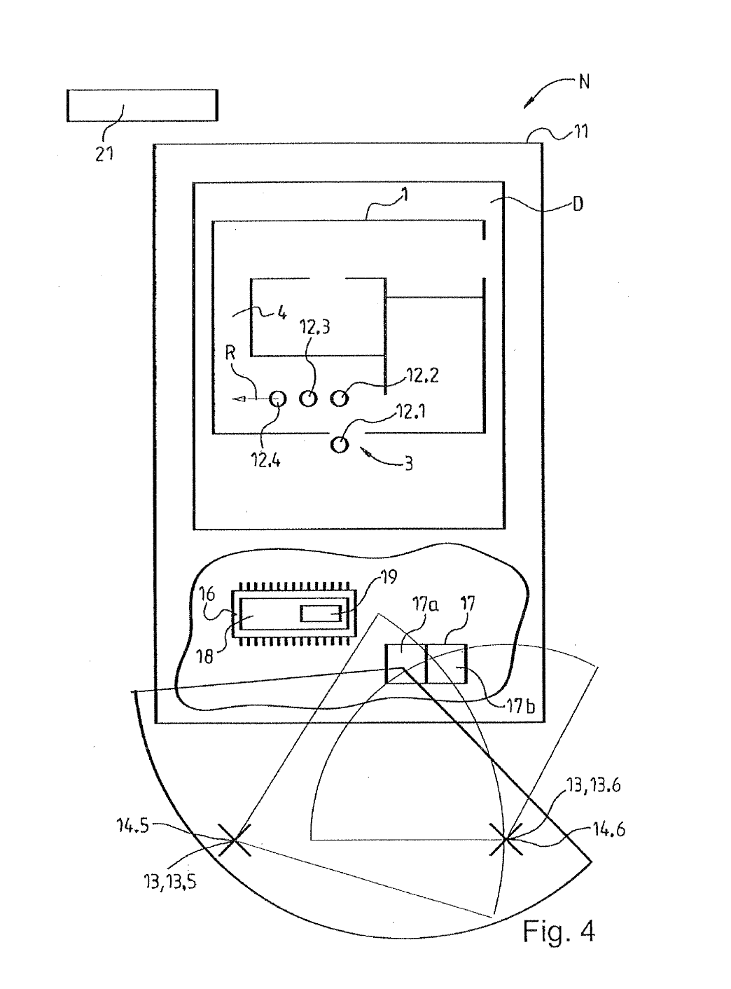

FIG. 1 shows a plan view of a floor plan 1 of a portion of a building 2. The floor plan 1 shows an entrance 3, which leads into a corridor 4 running in a U-shape, an exit 5, and two rooms 6, 7 accessible from the corridor 4. The premises shown are used as a shop area 8, in which shelves (not shown) stocked with goods are arranged against walls 9. Waypoints 10 of an electronic device 11 shown in FIG. 4, are marked by small circles in FIG. 1, and have been used in accordance with the navigation method according to the present invention to ascertain positions 12 denoted by the waypoints 10, along which the mobile electronic device 11 has been carried by a user. In the region of the shop area 8 are arranged numerous fixed transmitters 13, which are symbolized by small crosses in FIG. 1. A transmit range 14, within which the individual transmitters 13 can be detected at a minimum power, is indicated in each case by an arrow and a boundary line. Locations 15 at which the individual transmitters 13 are positioned are defined by coordinates in the present exemplary embodiment, where each of the individual locations 15 is denoted first by the x-coordinate followed by the y-coordinate. Hence, for example, the location 15.1 of the transmitter 13.1 is specified by the coordinates MB, and the location 15.7 of the transmitter 13.7 by the coordinates AA. For the sake of clarity, the floor plan 1 shown in FIG. 1 is shown again in FIG. 2 without the coordinate grid. Not all the positions, transmitters and transmit ranges are shown in the diagrams of FIGS. 1 and 2 in order to maintain clarity.

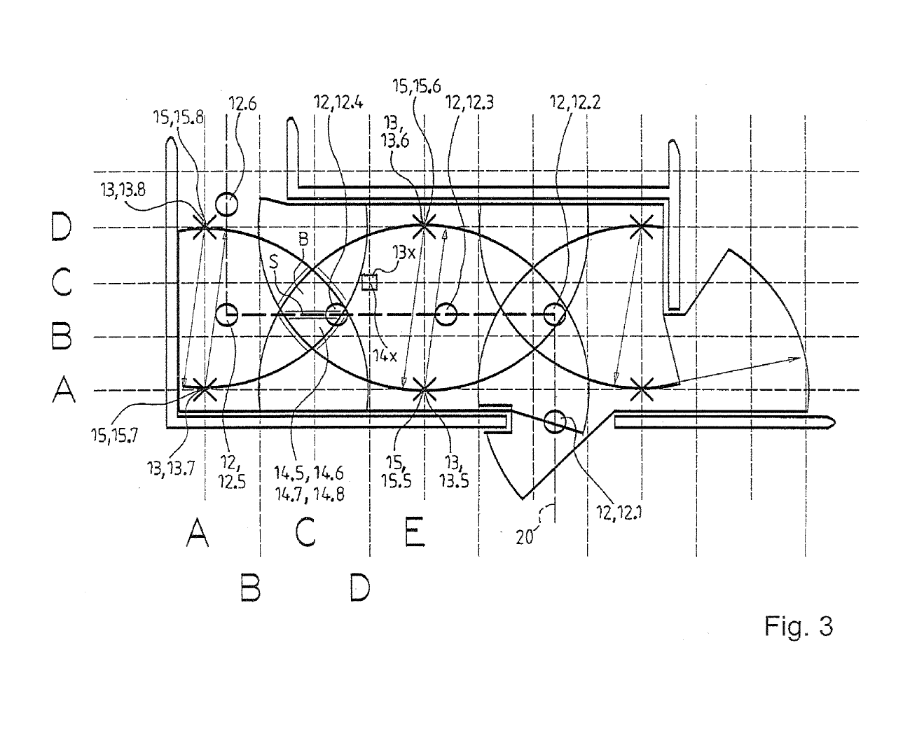

The description continues with reference to FIGS. 3 and 4, which shows a magnified view of a segment of FIG. 1. The electronic device 11 shown schematically in FIG. 4 is part of a navigation system N and comprises a display device D on which the floor plan 1 shown in FIGS. 1 and 3 is displayed in simplified form. The entrance 3 and the U-shaped corridor 4 can be seen in the simplified representation of the floor plan 1. The electronic device 11 also comprises a processor 16 and a Bluetooth module 17, which are shown symbolically in an opened-up area of the electronic device 11. In order to operate the electronic device 11, an application 18 in the form of a computer program is loaded into the processor 16, which application 18 comprises a database 19 in which are saved the floor plan 1 of the building 2 and at least one of the locations, 15 or 15.5-15.8, and the coordinates of the individual transmitters, 13 or 13.5-13.8 in FIG. 3, and the identifiers of the individual transmitters 13 or 13.5-13.8. In the present exemplary embodiment, the processor 16 comprises a memory integrated in the processor 16. This memory can also be arranged outside the processor 16, however, for example on a memory card. The Bluetooth module 17 comprises a transmitter 17a and a receiver 17b. In addition to the electronic device 11, FIG. 4 also shows the transmitters 13.5 and 13.6, which the receiver 17b of the Bluetooth module 17 of the electronic device 11 receives, from amongst the other transmitters 13, when the electronic device 11 is in the current position 12.4, which is displayed on the display device D. The position 12.4 and the positions 12.3, 12.2 and 12.1 correspond to the position 12.4 and to the positions 12.3, 12.2 and 12.1 denoted in FIG. 3. The position 12.3 is the position of the electronic device 11 previous to the position 12.4.

According to the navigation method according to the present invention and the pedestrian navigation method according to the present invention, the application 18 is initially loaded into the electronic device 11. In a navigation mode of the electronic device 11, a scan process to be executed by the Bluetooth module 17 is started cyclically. In the situation in which the electronic device 11 is in the position denoted by 12.4 in FIG. 3, a search is made here for transmitters present in the vicinity of the electronic device 11, and the identifiers and the signal strengths for the receivable transmitters 13.5 to 13.8 are detected here. After detecting this data, the application 18, which controls the Bluetooth module 17, terminates the communication with the receivable transmitters 13.5 to 13.8. Then, based on the contents of the database, the current position 12.4 of the electronic device 11 is ascertained by comparing the identifiers of the detected transmitters 13.5-13.8 with the locations 15.5-15.8 of the transmitters 13.5-13.8, which locations 15 are saved for the transmitters 13 in the database 19 of the application 18. In this process, the locations 15.5 to 15.8 for the transmitters 13.5 to 13.8 are ascertained by the coordinates EA, ED, AA and AD, resulting in the region B, bounded additionally by a thin line in FIG. 3, being possible for the position 12.4 of the electronic device 11. In addition, the position 12.4 of the electronic device 11 is specified more precisely by analyzing the signal strengths of the detected transmitters 13.5 to 13.8, wherein the transmitters 13.5 and 13.6 and the transmitters 13.7 and 13.8 are each detected with approximately the same signal strength in the situation described. Hence the segment S, bounded on both sides by thin lines, in the region B is essentially now possible for the position 12.4 of the electronic device, and the differences in the signal strength between the first transmitter pair 13.5 and 13.6 and the second transmitter pair 13.7 and 13.8 is used to calculate the marked position 12.4. A movement direction R of the electronic device 11 (shown in FIG. 4) is ascertained from a comparison of the current position 12.4 of the electronic device 11 with at least one previous position 12.3, or 12.3 and 12.2, of the electronic device 11. Then the ascertained position 12.4 and the ascertained movement direction R are output on the display device D of the electronic device 11. In parallel with this, it is intended to log the ascertained current position 12.4 in the database 19 of the application 18, in order to be able to analyze on the electronic device 11 or outside the electronic device 11, if required, a route 20 taken by the electronic device 11, which route 20 is obtained from the positions 12 and the waypoints 10 of the electronic device 11, and, for example, to be able to draw conclusions therefrom about products that are of particular interest to customers.

According to an embodiment variant, the current position is additionally specified more precisely by the application 18 ascertaining an entering and/or leaving of overlapping transmit ranges of different transmitters 13 by comparing the transmitters 13 detected in two positions 12.4 and 12.5 reached in immediate succession, and using this information to specify the current position more precisely. This is done, for example, between the positions 12.4 and 12.5, because the two transmitters 13.5 and 13.6 are no longer detected in the position 12.5 and hence a movement must have taken place out of the transmit range of the transmitters 13.5 and 13.6 and into the transmitter range of the transmitters 13.7 and 13.8.

In order to integrate further transmitters in the pedestrian navigation system, it is provided, for example, to place the further transmitter 13.x in a position such as that indicated by a small square in FIG. 3. If the electronic device 11 is again conveyed along the indicated route 20, in the positions 12.2 to 12.6 it will also see the transmitter 13.x, and assign thereto a location 15.x according to the position at which the data from the transmitter 13.x was received by the electronic device 11, and saves the coordinates of the transmitter 13.x for future navigation. By a plurality of measurements from different positions, in which the further transmitter 13.x is also detected, the exact location DC of this transmitter 13.x can be determined with increasing accuracy. An embodiment variant also provides that the locations of further transmitters ascertained by the electronic devices 11 are passed to a central computer 21 after at least one determination of location 15, so that the central computer 21 updates the application 18.

The present invention is not limited to exemplary embodiments shown or described, but includes developments of the present invention as part of intellectual property rights.

### LIST OF REFERENCES

1 floor plan
2 building
3 entrance
4 corridor
5 exit
6, 7 room
8 shop area
9 wall
10 waypoint of 11
11 electronic device
12; 12.1-12.6 position of 11
13; 13.1 & 13.5-13.8 transmitter
13.x further transmitter
14; 14.1 & 14.5-14.8 transmit range of 13
15; 15.1-15.8 location of 13
15.x location of 13.x
16 processor
17 Bluetooth module
17a Bluetooth transmitter
17b Bluetooth receiver
18 application
19 database
20 route
21 central computer
B region
B display device
N navigation system
R movement direction
S segment

1. A method for navigation, in particular a method for pedestrian navigation in a building, using a mobile electronic device and a plurality of transmitters arranged in the building, the method comprising the steps of:
loading into the mobile electronic device an application, wherein a floor plan of the building, a location of each of the plurality of transmitters and an identifier of each of the plurality of transmitters are saved in a database of the application,
cyclical starting of a scan process, each scan process comprising the steps of:
searching for signals from transmitters that are present in a vicinity of the electronic device,
detecting the identifier and a signal strength of each of the detected signals from transmitters in the vicinity of the electronic device,
terminating communication with the transmitters in the vicinity of the electronic device,
ascertaining the current position of the electronic device by comparing the identifiers of the detected transmitters with the locations of the transmitters saved in the database of the application,
specifying more precisely the current position of the electronic device by analyzing the detected signal strengths for each of the detected transmitters,
ascertaining a movement direction of the electronic device by comparing the current position of the electronic device with at least one previous position of the electronic device,
outputting at least one of the ascertained current position, the ascertained movement direction and further data available on the ascertained position on a display device of the electronic device, and logging at least one of the ascertained current position and the ascertained movement direction in the database of the application.

2. The navigation method as claimed in claim 1, further comprising starting the scan process at least at intervals not exceeding 5 seconds.

3. The navigation method as claimed in claim 1, further comprising ascertaining in the application at least one of an entering and a leaving of overlapping transmit ranges of different transmitters by comparing the transmitters detected in two positions reached in immediate succession, and using this information in the application to specify the current position of the electronic device more precisely.

4. The navigation method as claimed in claim 1, wherein the transmitters transmit in accordance with the Bluetooth standard and that the electronic device Is Bluetooth compatible.

5. The navigation method as claimed in claim 1, wherein each of the plurality of transmitters transmit at the same transmit power, which is designed to be of such a level that the transmit signal from each of the plurality of transmitters is received by the electronic device at a defined minimum transmit power at a distance of 2 to 5 meters.

6. The navigation method as claimed in claim 1, wherein the electronic device communicates with the transmitters such that the communication is made only as part of an inquiry process, and initiating a paging phase is avoided.

7. The method as claimed in claim 6, wherein a length of the inquiry process is shortened such that the process is terminated after one of a time interval that is shorter than an “interlaced scan” according to the Bluetooth standard, and after signals from at least three transmitters have been detected.

8. The navigation method as claimed in claim 1, wherein the electronic device is operated in the scan process as a master, wherein the vicinity of the master is scanned for data transmitted by Bluetooth transmitters working as slaves, and the scan process dispenses with responding to data received by the electronic device from the Bluetooth transmitters.

9. A method for integrating at least one further transmitter in a navigation system, in particular in a pedestrian navigation in a building, in which method the navigation system comprises pre-installed transmitters in addition to the at least one further transmitter, at least one electronic device and an application running on the electronic device, wherein a floor plan of the building, a location of each of the pre-installed transmitters and an identifier of each of the pre-installed transmitters are saved in a database of the application, the method comprising:
placing the at least one further transmitter in the building;
then moving the electronic device through the building while the application is running;
the application navigating on the basis of the pre-installed transmitters in accordance with a method as claimed in claim 1;
wherein the application, on receiving the identifier of the newly placed at least one further transmitter, calculates the location of the newly placed at least one further transmitter in relation to the pre-installed transmitters, saves the newly placed at least one further transmitter as a newly installed transmitter in the database and uses the newly installed transmitter for further navigation.

10. The method for integrating at least one further transmitter in the navigation system for navigation as claimed in claim 9, wherein the navigation system further comprises a central computer and the method further comprises the steps of:
signaling the location of the newly installed at least one further transmitter from each electronic device to the central computer;
logging the transmitted locations in the central computer;
ascertaining in the central computer from the coordinates of the signaled location for the newly installed at least one further transmitter, after analyzing the signals from at least two electronic devices, a definitive location of the newly installed at least one further transmitter, and passing this definitive location to the electronic devices so that the electronic devices save the newly installed at least one further transmitter as an installed transmitter in their database and use the newly installed at least one further transmitter for navigation.

11. The method as claimed in claim 10, further comprising deriving from the coordinates of the location of the transmitter from the identifier of the transmitter in the application without querying the database, the coordinates of the transmitter are held by each transmitter in a reference system that is used for navigation.

12. The navigation method as claimed in claim 2, further comprising starting the scan process at intervals not exceeding 3 seconds.

13. The navigation method as claimed in claim 4, wherein performing the scan process is in accordance with the Bluetooth 2 standard.
